(19) United States
(12) Patent Application Publication
(10) Pub. No.: US 2026/0368785 A1
(43) Pub. Date: Nov. 19, 2026

(54) TAP: AI-Powered API with Logo and Advertisement Detection for User Compensation in Messaging, Social Media, Content, and Gaming Platforms.

(71) Applicant: Carlos Mariano Roson Fontan, Agoura hills, CA (US)

(72) Inventor: Carlos Mariano Roson Fontan, Agoura hills, CA (US)

(21) Appl. No.: 19/718,183

(22) Filed: Jun. 24, 2026

(51) Int. Cl. G06Q 30/0241; G06Q 30/0273; G06V 10/82

(52) U.S. Cl. CPC G06Q 30/0277; G06Q 30/0273; G06V 10/82

(57) ABSTRACT

A computer-implemented platform for compensating users based on Al logo or advertisement detection in user-submitted images, integrated with messaging, social media, content, and gaming platforms. The platform comprises a client interface configured to send and receive images, a backend Al engine configured to detect predefined logos or advertisements and generate confidence scores, and a database configured to store user accounts, associated contact information, image metadata, and reward rules and balances. Upon detection of predefined logos or advertisements, points or compensation are assigned to user accounts. A compensation processor facilitates reward distribution, and users are notified in real-time. The Al engine continuously updates its object detection model using user-submitted images to improve detection accuracy. Optional leaderboards or achievement systems track accumulated rewards to increase user engagement.

### CROSS-REFERENCE TO RELATED APPLICATIONS (OPTIONAL)

This application claims priority to provisional Application No. 63/871,267 filed on Aug. 27, 2025 within Patent center #72043091

### FIELD OF THE INVENTION

The present invention relates generally to computer-implemented systems and methods for detecting objects in digital images using artificial intelligence (Al). In particular, the invention relates to detection of logos and advertisements in user-submitted images.

More specifically, the invention relates to platforms integrated with messaging applications, social media platforms, content platforms, or gaming platforms, wherein detected logos or advertisements are used to assign points or compensation to users reported to view the images. The platforms are configured to associate detected logos and/or advertisements with verified user contact information to enable reward allocation, while the AI engine continuously updates its object detection model based on user-submitted images to improve accuracy.

### BACKGROUND OF THE INVENTION

Digital platforms such as messaging applications, social media, content platforms, and gaming environments increasingly rely on user-generated images.

Existing systems may detect objects in images, but do not provide mechanisms to automatically compensate users based on detected content. Manual scoring or non-Al methods are slow, inaccurate, and do not scale efficiently. Current gamification approaches lack automated, adaptive rewards and cannot integrate seamlessly with real-time messaging or social media platforms. There is a technical need for a system that can automatically detect predefined objects, such as logos or advertisements, in user-submitted images, associate detected objects with verified user accounts, and assign points or compensation in real-time. Additionally, the system must maintain secure tracking of user rewards and support scalable integration across multiple platform types, while continuously improving detection accuracy through AI model updates.

### SUMMARY OF THE INVENTION

The present invention provides a computer-implemented Al-powered platform that detects predefined objects, such as logos or advertisements, in user-submitted images and assigns points or compensation to users from the images submission and view reports and based on detection results. The platform comprises a users' interface, a backend AI engine, a database for storing user accounts, a database for storing accounts for logo owners or advertisers from now on known as “Brands”, their images metadata with reward rules, and a compensation processor to facilitate reward distribution.

The platform can be integrated with messaging applications, social media platforms, content platforms, and gaming environments. Users are associated with verified shared contact information to enable compensation distribution. The AI engine continuously updates its object detection model based on incoming user images to improve accuracy over time. The system may also include leaderboards or achievement mechanisms to increase user engagement.

### Technical Advantages

Real-time AI object detection: The platform identifies logos and advertisements in user-submitted images immediately upon submission.

Automated user compensation: Points or monetary rewards are automatically assigned based on logos or advertisements AI detections and validation, not manual.

Integration with multiple digital platforms: The system can operate across messaging, social media, content, and gaming environments, ours or third parties'.

Adaptive AI learning: The AI engine continuously updates its object detection model using incoming user images to improve accuracy over time.

Secure and accurate reward tracking: User accounts, contact information, image metadata, and compensation balances are reliably stored and managed in a database.

Engagement support: Optional leaderboards and achievement systems increase user engagement by reflecting accumulated points or compensation.

### BRIEF DESCRIPTION OF THE DRAWINGS

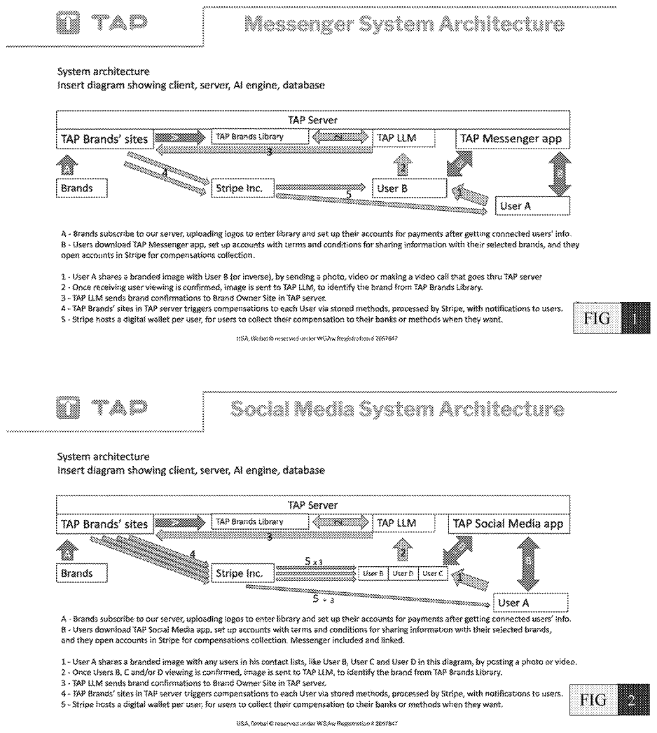

FIGS. 1, 2, 3 & 4. SYSTEMS' ARCHITECTURE (Ad/Ads=Advertisement/s)
Step A, Brands' uploads logos or ads for training and payment set up.
Step B, Users download and/or set up a TAP account with sharing terms and conditions and open an account in Stripe to get paid.

FIG 1. MESSENGER SYSTEM ARCHITECTURE
Step 1. User A shares image with User B, by photo, video or a video call
Step 2. User B confirms view. TAP identifies a logo/Ad and verifies it.
Step 3. TAP reports to its Brand if in our system, with user A & B info.
Step 4. TAP server triggers Brand compensations to each User
Step 5. Stripe hosts digital wallets per user, for their collection on time.

FIG. 2. SOCIAL MEDIA SYSTEM ARCHITECTURE
Step 1. User A posts an image in own profile for Users B, C, D, to see
Step 2. Users B, C, D confirm view. TAP finds a logo/Ad and verifies it.
Step 3. TAP reports its Brand if in our system, with user A, B, C, D info.
Step 4. TAP server triggers Brand compensations to Users and platform
Step 5. Stripe hosts digital wallets per user, for their collection on time.

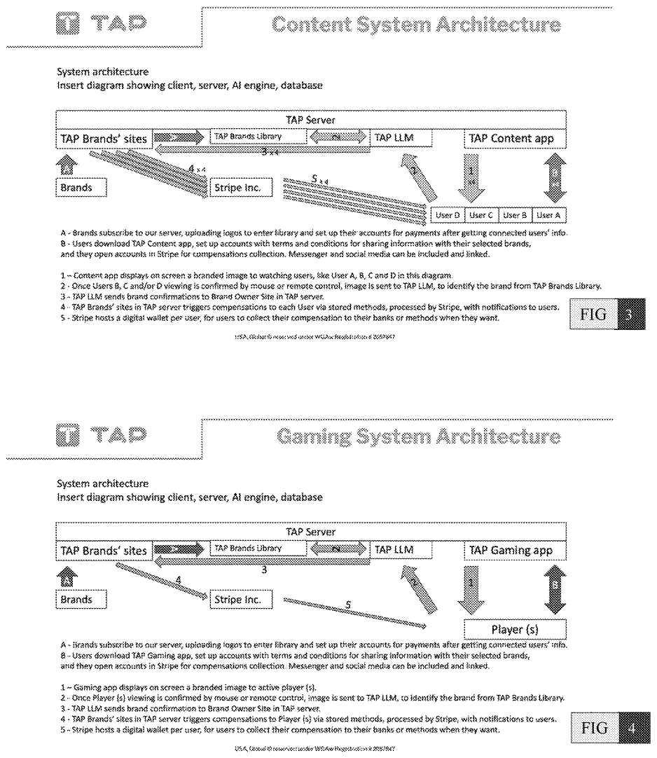

FIG 3. CONTENT PLATFORM SYSTEM ARCHITECTURE
Step 1. Content app shows a logo on screen for users A, B, C, etc.
Step 2. Users confirm view with remote. TAP finds logo/Ad and verifies.
Step 3. TAP reports its Brand if in our system, with user A, B, C info.
Step 4. TAP triggers Brand compensations to each User and platform.
Step 5. Stripe hosts digital wallets per user, for their collection on time.

FIG 4. GAMING PLATFORM SYSTEM ARCHITECTURE
Step 1. Gaming app shows on screen a logo/Ad to active player(s).
Step 2. Players confirm view with remote. TAP finds logo/Ad and verifies.
Step 3. TAP reports its Brand if in our system, with Players' info.
Step 4. TAP triggers Brand compensations to Players and platform.
Step 5. Stripe hosts digital wallets per user, for their collection on time.

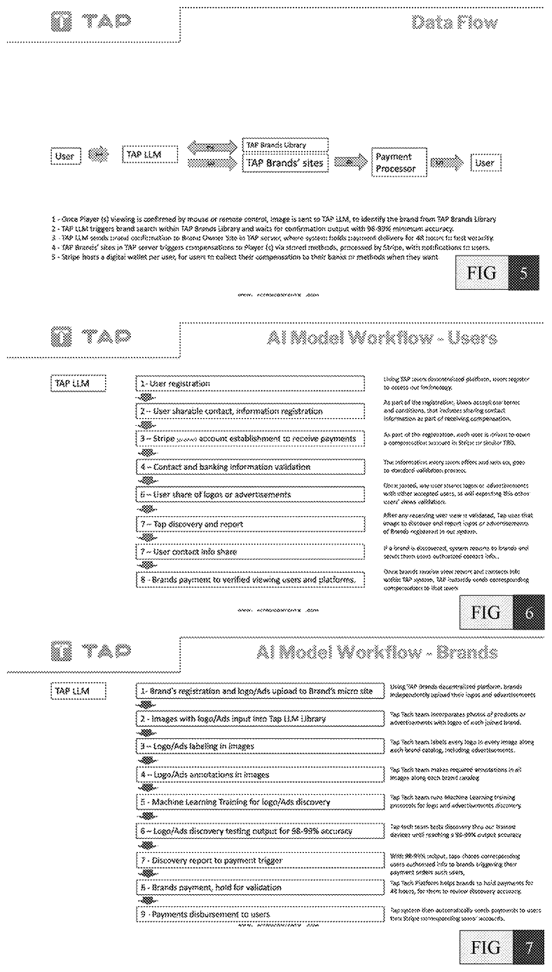

FIG 5. DATA FLOW
Step 1. User confirms view. Image is sent to TAP LLM, to find and verify a logo/Ad in TAP Brands' Library.
Step 2. TAP LLM searches to confirm needed output accuracy.
Step 3. TAP LLM sends logo/Ad confirmation to Brand if in TAP server,
Step 4. TAP triggers compensations to users via Stripe, with notification.
Step 5. Stripe hosts digital wallets per user, for their collection on time.

FIG 6. AI MODEL WORKFLOW-USERS
Step 1. User registration
Step 2. User, sharable contact information, registration
Step 3. Compensation account setup to receive payments
Step 4. Contact and banking information validation
Step 5. User share of logos or advertisements
Step 6. Tap discovery and report
Step 7. User automated contact info share after logo/ad verification
Step 8. Brands' payment to verified viewing users and platforms.

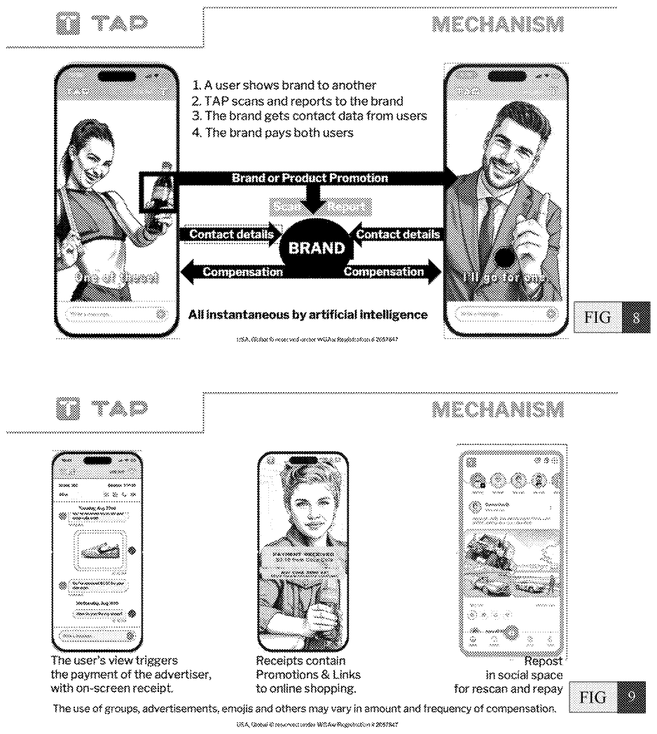

FIG. 7. AI MODEL WORKFLOW-BRANDS
Step 1. Brand's logo/Ads upload to Brand's micro site
Step 2. Images or Ads with logo ingested into Tap LLM Library
Step 3. Logo/Ads labeling in images or Ads
Step 4. Logo/Ads annotations in images or Ads.
Step 5. Machine Learning Training for Logo or Ads discovery
Step 6. Logo discovery output testing for needed accuracy
Step 7. Discovery report to brand for last verification option
Step 8. Verification report to payment processor
Step 9. Payments disbursement to users via payment processor.

FIG. 8. MESSENGER INTERFACE MECHANISM
Step 1. A user shows image with logo or ads to another user
Step 2. TAP verifies logo/ads and reports to Brand
Step 3. Brand gets report and contact info from users.
Step 4. The Brand compensates both users

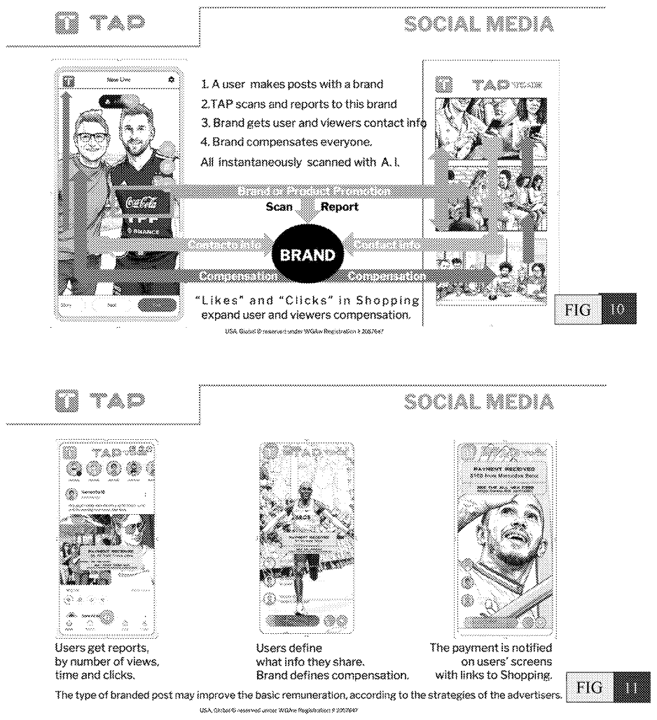

FIG. 9. MESSENGER INTERFACE MECHANISM. REPORTS.
Users receive on-screen receipts with promotions & links
Users can reshare images, expanding reach and business

FIG. 10. SOCIAL MEDIA INTERFACE MECHANISM
Step 1. A user posts an image with logo or ads
Step 2. TAP verifies logo/ads and reports to owning Brand
Step 3. Brand gets report with all viewers contact info.
Step 4. Brand pays all verified viewers and platform.

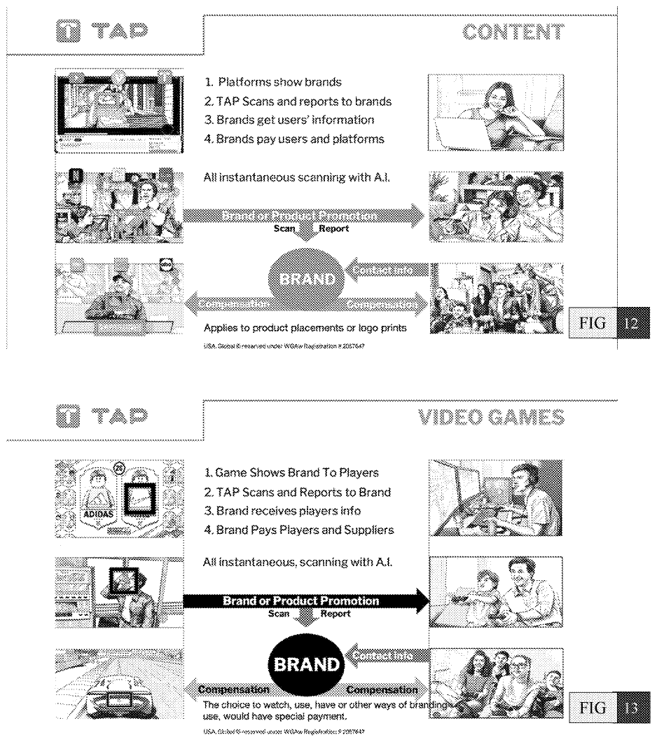

FIG. 11. SOCIAL MEDIA INTERFACE MECHANISM. REPORTS
Users receive on-screen receipts with promotions & links
Users can reshare images, expanding reach and business

FIG. 12. CONTENT PLATFORM INTERFACE MECHANISM
Step 1. A platform shows logo/ads on screen to viewers
Step 2. Viewers confirm Logo/ads view with remote, or Smartphone.
Step 2. TAP verifies logo/ads and reports to owning Brand
Step 3. Brand gets report with all verified viewers contact info
Step 4. Brand pays all verified viewers and platform.
Step 1. Viewers receive on-screen receipts with promotions & links

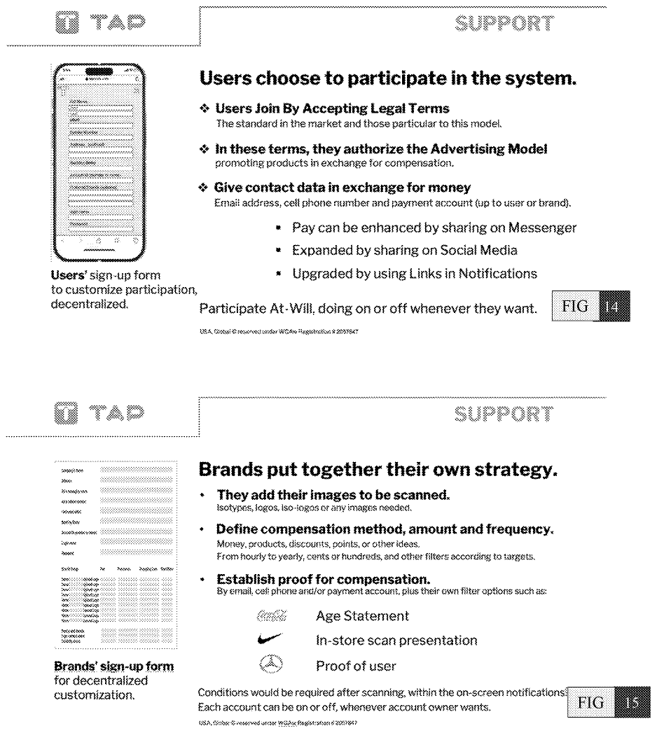

FIG. 13. GAMING PLATFORM INTERFACE MECHANISM
Step 1. A platform shows logo/ads on screen to players
Step 2. Players confirm logo/ads view with remote, or Smartphone.
   TAP verifies logo/ads and reports to owning Brand
Step 3-Brand gets report with all players contact info.
Step 4-Brand pays players and platform.
   Players receive on-screen receipts with promotions & links.

FIG. 14. SUPPORT. Users.
Users join accepting legal terms, participating of advertising
Users accept sharing their contact info in exchange for money
Participation at will, going on-off anytime.

FIG. 15. SUPPORT. Brands.
Brands' setup their own compensation strategy, decentralized
They add their images to be trained and verified.
Define compensation method, amount and frequency
Establish proof for compensation at will.

### DETAILED DESCRIPTION OF THE INVENTION

### System Overview (FIGS. 1 a 4)

AI API software incorporated in Messenger/Social Media Platform/Content Platform, helping users to share logos or advertisements with other users and get compensated by Brands for such promotion and for sharing contact information.

Mobile Client Application: Users capture and send images to others through the messaging interface, available in live video calls as well. Logos or ads are detected and reported to Brand, who automatically compensates users by sharing logo or ad, and their contact info. Brand compensates platform and app.

Social Media: Users capture and post images for others to see through the social media interface. Logos or ads are detected and reported to brand, who automatically compensates all involved users for sharing the image and their contact info. Brand also compensates social media platform and app.

Content Platform: Platform post logos or ads for others to see while watching content. Logos are detected and reported to brand when view is verified, who automatically compensates all involved users for sharing images and their contact info. Brand also compensates content platform and app.

Gaming Platform: Platform post logos or ads for others to see while playing.

Logos are detected and reported to brand when view is verified, who automatically compensates all involved users for sharing brand and their contact info.

Brand also compensates platform and app

Backend AI server to learn, discover and verify images that are being shared. Receives images, processes them to detect logo or ads in system brand library, using AI models, for validation.

Database for user data: Contains participant users' contact info to be shared with paying Brands. Stores user accounts, compensation balances, images metadata, and AI detection results.

Recommendation/Reward Engine: Determines points allocation, updates user balances, and optionally triggers notifications or achievements.

Payment processing platform: An independent official payment processor collects, accumulates and facilitates delivery of the compensations.

### Data Collection and Processing (FIG. 5)

Data Types: Brand's logos and ads, users contact and banking data, all authorized when signing up with terms and conditions.

Brands' Logo Data: Brands' submitted logos and ads, metadata (timestamp, user ID), and optional contextual info (location, captions), get trained for proper identification, giving values and frequency of compensations filtered for each user, automatically.

Processing Steps: Training images acquisition→Preprocessing→encoding→AI model input→scoring→ranking→output.

The AI engine enables adaptive logo or advertisement recognition, ensuring high accuracy in diverse lighting, angles, and backgrounds.

User Input Data: User submitted photos, metadata (timestamp, user ID), optional contextual info (location, captions), get uploaded for our AI system to analyze and identify automatically.

Processing Steps: Image acquisition→sharing with other users→deliver to server→AI model input→scoring→ranking→output→compensation order and notification.

Altogether, brand registration and training→consumer registration,→information sharing,→brands validation→compensation.

### AI Model Description (FIGS. 6 and 7)

Types: Convolutional Neural Network (CNN), optionally combined with object recognition algorithms and/or hybrid ML models.

### Workflow

Input preprocessed image→Predict presence and location of predefined logos or advertisements.→Generate detection confidence scores.→Assign points if detection confidence exceeds a threshold→Logo detection report to brand.→Compensation to user confirmation to payment processor→Processor payment disbursement to user account.→Payment notification to user.→Log detected logos or advertisements for continuous training→User-submitted images and feedback can be used to retrain AI models, improving detection accuracy over time.

### User Interface Interaction (FIGS. 8 a 13)

Users' choices for images share methods. Camera, image album, programming. Users' images sharing→Users' view confirmation→Compensation on-screen notification with info and links→Users' back end with leaderboard information→Compensations updated in real-time and reflected in each user's account.

### Subscription Interface for Users (FIG. 14)

A space to add all required information to participate, such as name, contact info, banking info and legal terms and conditions acceptance including transactional model participation authorization.

### Subscription Interface for Brands As Logo Owners or Advertisers (FIG. 15)

A space to add all required information to participate, such as company's names, contacts info, banking info and legal terms and conditions acceptance including model participation, together with a space to upload required images for training and discovery and spaces to define compensation methods, amounts, frequency and proofs methods.

### Examples/Use Cases—Users (FIGS. 8 a 13)

Example 1: Messenger version. User A sends an image to User B. It can also be that Usar A, video calls User B, and shows a product or an image. The image contains a pre-defined logo or advertisement. User B confirms viewing it. The backend AI system detects the logo or advertisement by both users' visualization. AI validates logo or advertisement existence in our clients Brands' database. AI defines compensation based in Brands' preset values. AI sends a report to corresponding Brand company, including Users A and B authorized contact info. AI orders payment processor to charge Brand and disburse such amount to User A and B. AI notifies them of the compensation earned with an on-screen notification that includes paying Brand's info and links. AI updates Users' balances in the system.
Example 2: User B posts an image in his social media space, with 3 detectable logos. The AI model detects 3 objects, and repeats the process in Example 1, to compensate User B, for each confirmed viewer in his social space, as well as compensating each of these viewers, automatically, through our AI system.

Example 3: A content platform runs a movie with certain logos appearing along it. Viewers confirm view with their remote controls. The AI model validates the detection, assigns logo or advertisement for each active proven viewer to total the points for each one, and update all viewers accounts in real-time. It compensates platform too.

Example 4: A game platform displays logos appearing along a game. Players see them and validate the detection with their remote controls. The AI model validates the detection, assigns points per object for each active proven viewer to total the points for each one, and update all viewers accounts in real-time. It compensates platform too.

In all cases, leaderboard feature updates automatically based on points earned from AI object detections, encouraging users to participate more actively.

1. An AI-powered system for compensating users when sharing images in which logos or advertisement get detected, validated and then reported to corresponding participant logo owners or advertisers, for them to release the compensation to such sharing users that also are sharing their contact information, all happening within messaging, social media, content, or gaming platforms, comprising:
An interface for platforms such us messengers, social media, content or gaming platforms, configured for users to send, receive or share images with other users.
A feature for users to confirm shared images' views.
A backend server hosting an AI engine configured to analyze shared images, detect the predefined logos or advertisements ownership in our data base of participant logo owners or advertisers and generate validation confidence scores for each detection.
A system to connect scores confirmation into pre-established compensation punctuation or values, from corresponding participant logo owners or advertisers.
A system to share pre-established, authorized users' contact information, as condition to compensation delivery to such users.
A compensation processor configured to execute transfer of compensation from logo or advertisement owners to users.
A feature to report each compensation to each corresponding user.

2. An AI-powered system of claim 1 further comprises, the AI engine uses convolutional neural networks for object recognition, such as logos or advertisement in images shared by users.

3. An AI-powered system of claim 1 further comprises, users to subscribe, authorize terms and conditions, and input all required information to be part of the database configured to store user accounts, associated contact information, image metadata, and points or compensation balances and collection methods.

4. An Al-powered system of claim 1 further comprises, logo owners or advertisers subscribe, authorize terms and conditions, and input all required information to participate, like logos and advertisements, participation frequencies and rules and methods for users' compensation, joining the creation of a database for users' info collection, compensation data sharing, logos or advertisements metadata and storage.

5. An AI-powered system of claim 1 further comprises a sub system for compensation report notifications, to include values messages to users, links to logo and advertisers' websites, and access to balance information.

6. An Al-powered system of claim 1 further comprises a sub system to include third parties to operate payment processes.
